(19) United States
(12) Patent Application Publication
(10) Pub. No.: US 2025/0020849 A1
(43) Pub. Date: Jan. 16, 2025

(54) ILLUMINATION DEVICE, LIGHT GUIDE OF ILLUMINATION DEVICE AND DISPLAY DEVICE COMPRISING ILLUMINATION DEVICE

(71) Applicant: JAPAN DISPLAY INC., Tokyo (JP)

(72) Inventors: Tomoya TEZEN, Tokyo (JP); Kosuke MATSUBARA, Tokyo (JP)

(21) Appl. No.: 18/756,265

(22) Filed: Jun. 27, 2024

(30) Foreign Application Priority Data
Jul. 14, 2023 (JP) 2023-115943

(51) Int. Cl. F21V 8/00

(52) U.S. Cl. CPC G02B 6/002

(57) ABSTRACT

According to one embodiment, an illumination device includes a light guide including an emission surface and an incident surface, the incident surface including an uneven pattern with a convex portion having a height of 0.01 to 0.4 mm, and a light emitting element provided to oppose the incident surface and adhered to the uneven pattern by an adhesive.

### CROSS-REFERENCE TO RELATED APPLICATIONS

This application is based upon and claims the benefit of priority from Japanese Patent Application No. 2023-115943, filed Jul. 14, 2023, the entire contents of which is incorporated herein by reference.

### FIELD

Embodiments described herein relate generally to an illumination device, a light guide of the illumination device, and a display device comprising the illumination device.

### BACKGROUND

Liquid crystal displays are widely used as display devices in smartphones, tablet computers, car navigation systems, and the like. In general, liquid crystal display devices comprise a liquid crystal display panel and an illumination device (backlight device) disposed to overlap the rear surface of the liquid crystal display panel to illuminate the liquid crystal display panel. The backlight device includes a reflective layer, a light guide, an optical sheet, a light source device that supplies light entering the light guide.

The light source device, for example, a light emitting diode (LED), is provided to oppose an end surface (incident surface) of the light guide. Usually, due to assembly errors or tolerances, a gap (air layer) is created between the disposed LED and the light guide. As a result, the light emitted from the LED passes through the optical path of the LED sealant (resin), the air layer, and the light guide (resin), and in this process, the light is significantly lost due to the difference in refractive index between the air layer and the resin.

Under these circumstances, a method has been proposed to fill the air layer with an optical adhesive having a refractive index equivalent to that of the resin. However, when liquid adhesive is used in this method, the adhesive may flow out from the end surface of the light guide, causing drawbacks such as adhesion failure and the occurrence of contamination.

### BRIEF DESCRIPTION OF THE DRAWINGS

FIG. 1 is a perspective view showing a display surface side of a liquid crystal display device according to the first embodiment.

FIG. 2 is an exploded perspective view of the liquid crystal display device.

FIG. 3 is an exploded perspective view of a backlight device of the liquid crystal display device.

FIG. 4 is a cross-sectional view of a light source-side portion of the liquid crystal display device taken along line A-A of FIG. 1.

FIG. 5 is a plan view showing a light source device of the backlight device.

FIG. 6 is a perspective view showing the light source device and a light guide.

FIG. 7 is a perspective view showing an incident surface and uneven pattern of the light guide.

FIG. 8 is an enlarged perspective view showing the uneven pattern.

FIG. 9 is a perspective view showing the light guide and LEDs adhered on the uneven pattern of the light guide.

FIG. 10 is an enlarged perspective view showing the light guide and the LED.

FIG. 11 is a diagram schematically showing a processing step of applying adhesive to the light guide.

FIG. 12 is a perspective view showing the light guide and the LED before adhesion.

FIG. 13 is a diagram schematically showing a processing step of adhering the LED to the light guide.

FIG. 14 is a perspective view showing an uneven pattern of the light guide according to the first modified example.

FIG. 15 is a perspective view showing an uneven pattern of the light guide according to the second modified example.

FIG. 16 is a perspective view showing an uneven pattern of the light guide according to the third modified example.

FIG. 17 is a perspective view showing an uneven pattern of the light guide according to the fourth modified example.

FIG. 18 is a perspective view showing an uneven pattern of the light guide according to the fifth modified example.

FIG. 19 is a perspective view showing an uneven pattern of the light guide according to the sixth modified example.

FIG. 20 is a perspective view showing a guide plate display of a display device according to the second embodiment.

FIG. 21 is a perspective view showing a light guide and LEDs of a display device according to the third embodiment.

FIG. 22 is a perspective view showing a light guide of a display device according to the fourth embodiment.

### DETAILED DESCRIPTION

Various embodiments will be described hereinafter with reference to the accompanying drawings. In general, according to one embodiment, an illumination device comprises a light guide including an emission surface and an incident surface, the incident surface including an uneven pattern with a convex portion having a height of 0.01 to 0.4 mm, and a light emitting element provided to oppose the incident surface and adhered to the uneven pattern by an adhesive.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

### First Embodiment

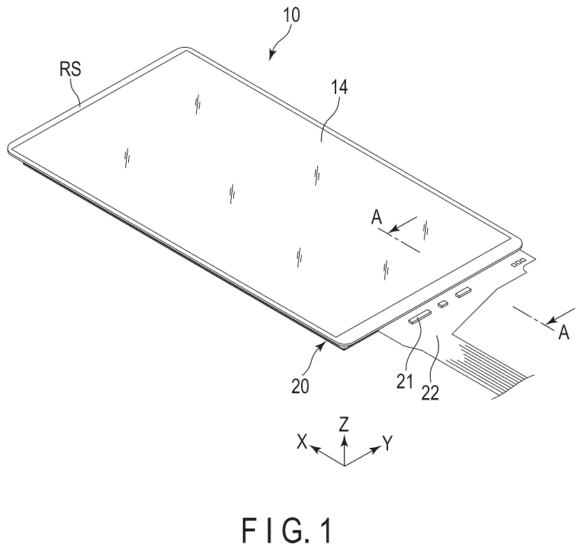

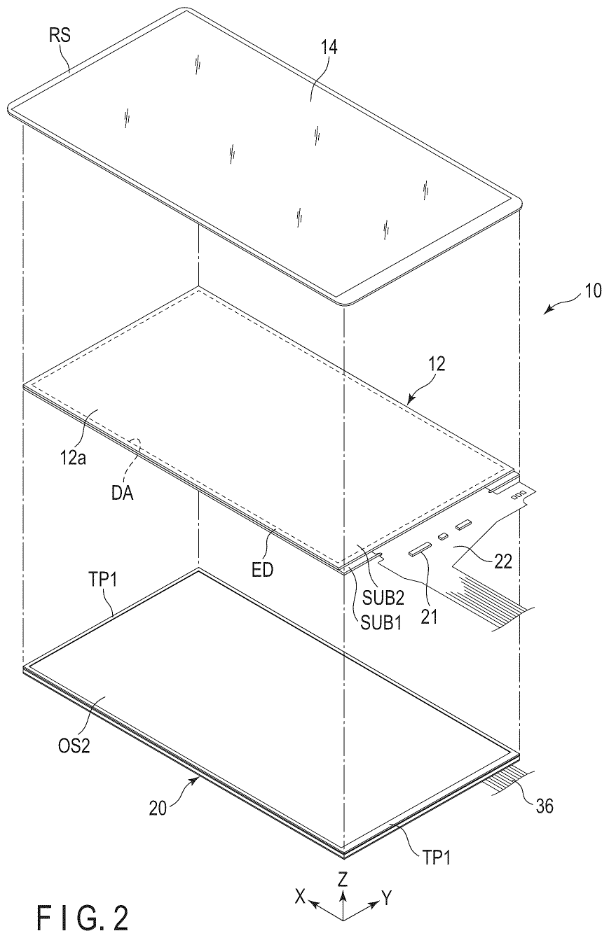

FIG. 1 is a perspective view showing a display surface side of a liquid crystal display device according to the first embodiment, and FIG. 2 is an exploded perspective view of the liquid crystal display device.

A liquid crystal display device 10 can be built into and used in various electronic devices, such as smartphones, tablet terminals, cellular phones, laptop PCs, portable game machines, electronic dictionaries, TV devices, car navigation systems, and the like.

As shown in FIGS. 1 and 2, the liquid crystal display device 10 comprises a display panel 12, which is an active matrix liquid crystal display panel, a cover panel 14 disposed to overlap a display surface 12a, which is one surface of the display panel 12 and cover the entire display surface 12a, and a backlight device 20 disposed to oppose a rear surface, which is the other surface of the display panel 12. In some of the figures, a first direction Y, a third direction X orthogonal thereto, and a second direction Z orthogonal to the first and third directions are defined. In this embodiment, for example, the longitudinal direction of the liquid crystal display 10 is referred to as the third direction X, the width direction thereof is referred to as the first direction Y, and the thickness direction is referred to as the second direction Z.

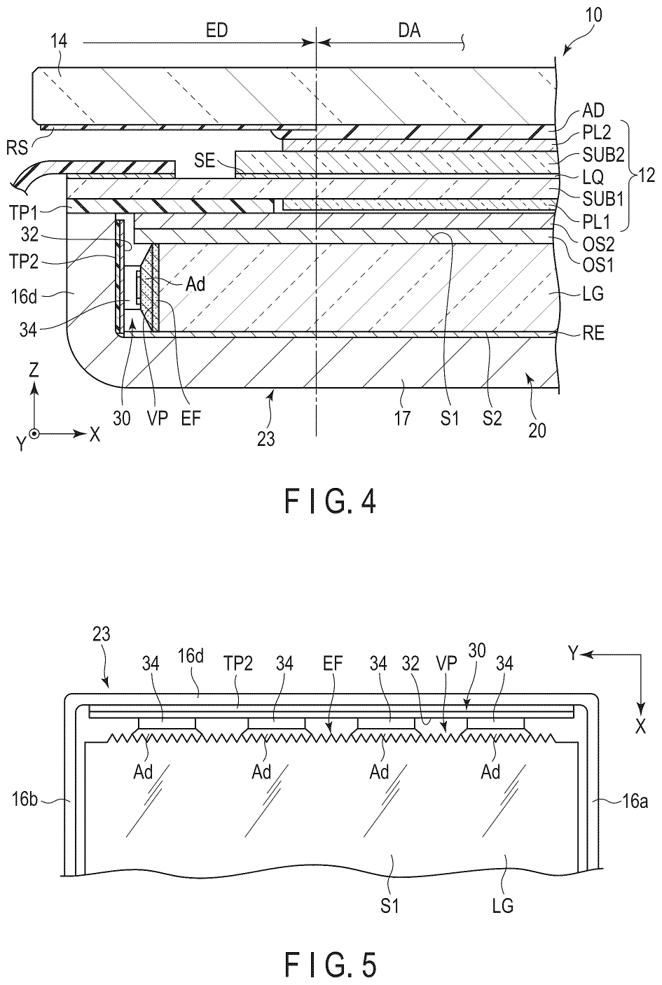

FIG. 4 is a cross-sectional view of a light source side of the liquid crystal display device taken along line A-A in FIG. 1. As shown in FIGS. 2 and 4, the display panel 12 comprises a rectangular first substrate SUB1, a rectangular second substrate SUB2 disposed to oppose the first substrate SUB1, and a liquid crystal layer LQ provided between the first substrate SUB1 and the second substrate SUB2. The first substrate SUB1 and the second substrate SUB2 are each formed of a transparent insulating substrate such as glass or resin plates. The peripheral portion of the second substrate SUB2 is attached to the first substrate SUB1 by a sealant SE. To the surface of the second substrate SUB2, a polarizer PL2 is attached to form the display surface 12a of the display panel 12. A polarizer PL1 is attached to the surface of the first substrate SUB1 (the rear surface of the display panel 12).

In the display panel 12, a rectangular display area (active area) DA is provided in a region which is located on an inner side of the sealant SE when the display surface 12a is viewed in plan view. In this specification, the plan view refers to the state in which the display panel is viewed from the normal direction of the surface of the display panel 12. Images are displayed on the display area DA. A rectangular-shaped frame area (non-display area) ED is provided around the display area DA. The display panel 12 has a transmissive display function for displaying images by selectively transmitting light from the backlight device 20 to the display area DA.

In the example illustrated, a flexible printed circuit board (FPC) 22 is joined to a short edge-side end portion of the first substrate SUB1 and extends outward from the display panel 12. In the FPC 22, as a signal supply source that supplies signals necessary to drive the display panel 12, semiconductor devices such as a drive IC chip 21 and the like are mounted.

As shown in FIGS. 2 and 4, the cover panel 14 is formed from a glass plate or acrylic transparent resin, for example, and has a rectangular plate shape. The cover panel 14 covers the entire display surface 12a of the display panel 12. A frame-shaped light-shielding layer RS is formed in the peripheral portion of the rear surface of the cover panel 14 (a surface on a display panel 12 side or a surface on an opposite side to the surface opposing the observer). Note that the light-shielding layer RS may as well be formed on the upper surface (display surface) of the cover panel 14.

The rear surface of the cover panel 14 is attached to the polarizer PL2 of the display panel 12 by an adhesive sheet AD made, for example, of a bond or adhesive having light-transmitting properties or an optical transparent resin.

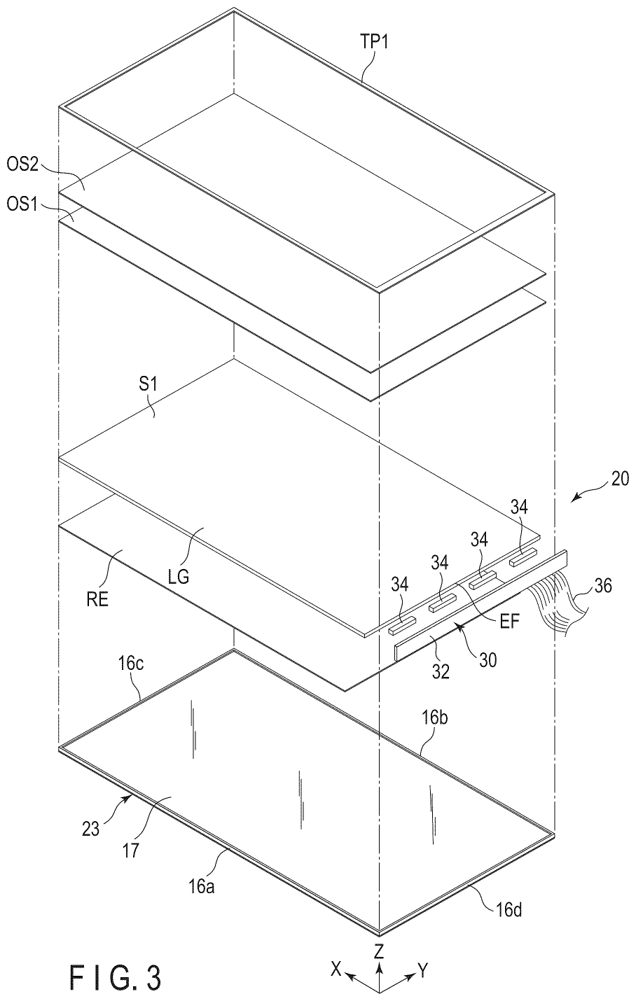

FIG. 3 is an exploded perspective view of the backlight device 20. As shown in FIGS. 2, 3, and 4, the backlight device 20, which constitutes an illumination device, comprises a case (bezel) 23, a plurality of optical members arranged within the case 23, and a light source device 30 that supplies light entering the optical members.

The case 23 includes a rectangular bottom plate 17 and a plurality of side plates provided to stand along side edges of the bottom plate 17. The side plates include a pair of long-side plates 16a and 16b opposing each other and a pair of short-side plates 16c and 16d opposing each other. For example, the case 23 is formed to be integrated as one body of a metal such as stainless steel (SUS). Note that the material of the case 23 is not limited to metal, but can also be formed entirely or partially from a resin such as polycarbonate or the like.

The optical members of the backlight device 20 include a reflection sheet RE, a light guide LG, which are placed on the bottom plate 17 in the case 23, and a plurality of, for example, two sheets, namely, a first optical sheet OS1 and a second optical sheet OS2, disposed to overlap each other on the light guide LG.

The reflective sheet RE is formed into a rectangular shape in plan view, so as to be slightly smaller in dimensions than dimensions of the bottom plate 17. The reflective sheet RE is placed on the bottom plate 17 so as to cover substantially the entire surface of the bottom plate 17.

The light guide LG is formed from a translucent resin, for example, acrylic or silicon-based resin, into a rectangular shape and has a rectangular prism shape. The light guide LG includes a first main surface S1 as an emitting surface, a second main surface S2 on an opposite side to the first main surface S1, and a plurality of side surfaces. In this embodiment, a side surface on a short side of the light guide LG is referred to as an incident surface EF.

Note that such a type is adopted here that the thickness of the side surface, as the thickness of the light guide LG, is about 0.2 to 0.5 mm (200 to 500 μm), for example.

The light guide LG is disposed in the case 23 while the second main surface S2 side is opposing the reflective sheet RE and placed on the reflective sheet RE. The incident surface EF of the light guide LG opposes the short-side plate (first-side plate) 16d on the light source side while interposing a gap therebetween.

According to this embodiment, as the first optical sheet OS1 and the second optical sheet OS2, for example, a light-transmissive diffusion sheet or prism sheet made of synthetic resin such as polyethylene terephthalate is used. The optical sheets OS1 and OS2 are placed so as to be stacked in this order on the first main surface S1 of the light guide LG. Note that the number of optical sheets is not limited to two, but three or more or two or less optical sheets may be used.

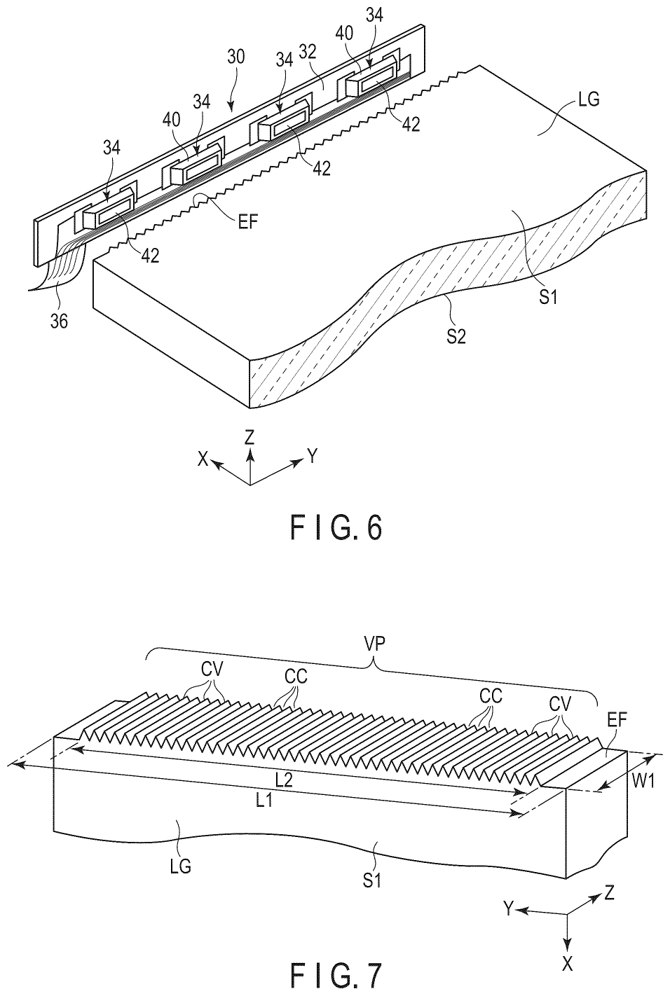

Next, the light source device 30 and the light guide LG will be described in detail. FIG. 5 is a plan view showing a light source-side end portion of the backlight device, and FIG. 6 is a perspective view showing the light source device and the light guide separately.

As shown in FIGS. 5 and 6, the light source device 30 comprises, for example, a slender strip-shaped wiring substrate 32 and a plurality of, for example, four light sources mounted on the wiring substrate 32. As the light source, light emitting elements, for example, light emitting diodes (LED) 34 are used. For the wiring substrate 32, a flexible printed circuit board (FPC) is used. The wiring substrate 32 includes an insulating layer made of polyimide or the like and a conductive layer, such as copper foil, formed on the insulating layer. The conductive layer is patterned to form a plurality of connection pads and a plurality of wiring lines. Further, the wiring substrate 32 includes a connection end portion 36 extending from one side edge of the substrate.

As shown in FIG. 6, the LED 34 includes an approximately rectangular-prism-shaped case (package) 40 formed of, for example, resin. The upper surface of the case 40 forms a light emitting surface 42 through which light can be transmitted, and the bottom surface forms a mount surface on an opposite side to the light emitting surface 42. A pair of connection terminals 43 (see FIG. 9) are provided on the mount surface. In the case 40, there are provided LED chips, which are light emitting bodies (light emitting chips) not shown in the figure, a reflector, a luminescence or sealing resin, bonding wires connecting the LED chips to the connection terminals, and the like.

The LEDs 34 are mounted on the wiring substrate 32 by their mounting surface, and the connection terminals 63 are electrically bonded to the connection pads of the circuit board 32. Further, the plurality of LEDs 34 are arranged on the circuit board 32 in a row, with the longitudinal direction of the case 40 aligned with the longitudinal direction of the circuit board 32 (first direction Y). The light emitting surface 42 of each LED 34 is positioned substantially parallel to the wiring substrate 32 so as to oppose the incident surface EF of the light guide LG.

As shown in FIGS. 4 and 5, the wiring substrate 32 of the light source device 30 configured as described above is disposed to oppose a short side plate 16d of the case 23 and is attached to the inner surface of the short side plate 16d by, for example, a double-sided tape TP2. As a result, the wiring substrate 32 extends in the first direction Y and opposes substantially the entire incident surface EF of the light guide LG. Further, the light emitting surface 42 of each of the LEDs 34 mounted on the wiring substrate 32 opposes the incident surface EF of the light guide LG.

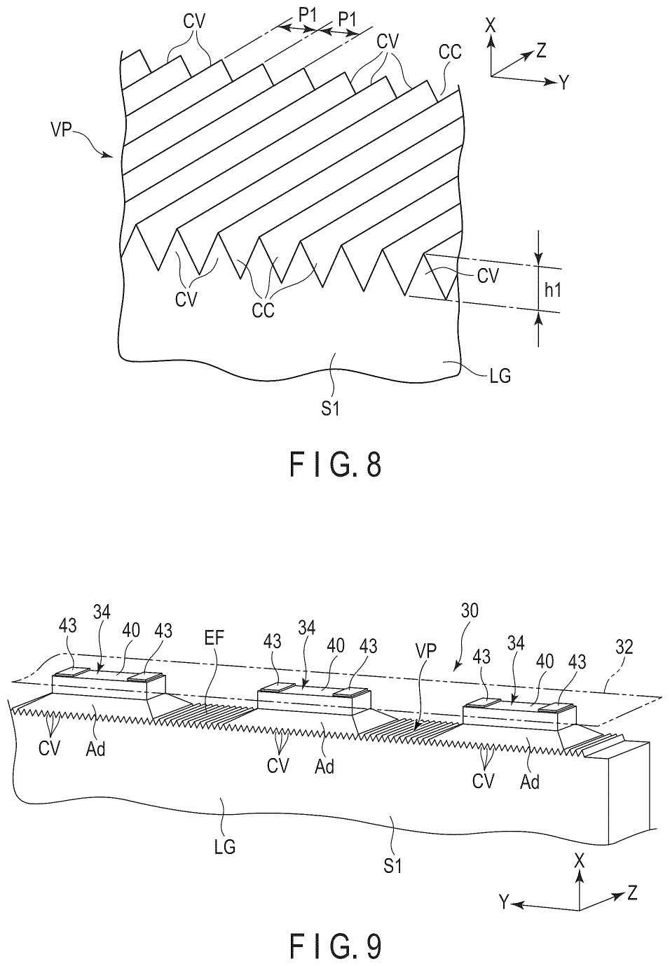

On the other hand, the light guide LG includes an uneven (concave-convex) pattern VP integrally formed on the incident surface EF. FIG. 7 is a perspective view showing the incident surface and the uneven pattern of the light guide, and FIG. 8 is an enlarged perspective view showing the uneven pattern.

As shown in the figures, according to this embodiment, the uneven pattern VP is formed in a saw blade pattern, for example. That is, the uneven pattern VP is constituted by a plurality of convex portions CV each having a triangular cross section and a plurality of concave portions CC each having a triangular cross section arranged alternately. In this embodiment, the incident surface EF of the light guide LG has a rectangular shape. That is, the incident surface EF includes a pair of long sides parallel to each other and a pair of short sides parallel to each other. In the following, with regard to the incident surface EF, the direction parallel to the long sides may be referred to as the longitudinal direction or the first direction Y, and the direction parallel to the short sides may be referred to as the width direction, the thickness direction, or the second direction Z.

When the incident surface EF is rectangular in shape having a length L1 in the first direction Y and a width W1 in the second direction Z, the convex portions CV and the concave portions CC are formed over the entire length of width W1 in the second direction Z. With this configuration, both end faces of each convex portion CV in the longitudinal direction are located to be flush with each of the first main surface S1 and the second main surface S2 of the light guide LG. Note here that the width W1 of the incident surface EF, that is, the thickness of the light guide LG is assumed to be sufficiently greater than the width of the case of the LED 34.

The plurality of convex portions CV and the plurality of concave portions CC are alternately arranged in the first direction Y (the longitudinal direction of the incident surface EF). The uneven pattern VP is provided over substantially the entire length of the incident surface EF in the longitudinal direction Y. In this embodiment, the length L2 of the uneven patterns VP in the first direction Y is shorter than the length L1 of the incident surface EF. Flat regions, without uneven patterns, are provided at both end portions of the incident surface EF in the longitudinal direction Y, but these flat regions may be omitted. That is, it may as well be configured as that the uneven pattern VP is provided up to both end portions of the incident surface EF in the longitudinal direction Y.

As shown in FIG. 8, each of the convex portions CV is formed to have a protrusion height h1 in a range of 0.01 to 0.4 mm, for example. In this embodiment, the plurality of convex portions CV have a common protrusion height h1. A pitch P1 between each adjacent pair of the convex sections CV in the longitudinal direction Y is set to, for example, 0.05 to 0.3 mm.

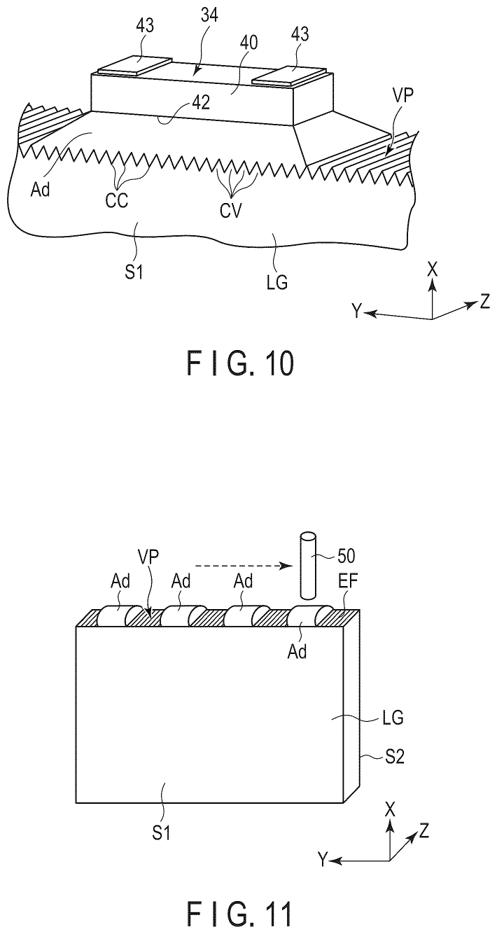

FIG. 9 is a perspective view showing the light guide and the LEDs bonded on the uneven pattern of the light guide, and FIG. 10 is an enlarged perspective view of the light guide and the LEDs.

As shown in the figures, the gap (air layer) between the emitting surface 42 of each of the LEDs 34 and the incident surface EF of the light guide LG is filled with an adhesive Ad to fill the gap. That is, each LED 34 is adhered to the uneven pattern VP of the incident surface EF by the adhesive Ad. For example, the adhesive Ad used here is formed of an optical clear resin (OCR) having a refractive index after curing of 1.4 or higher and also equal to the refractive index of the light guide LG or less, and also having a haze of 5% or lower. Further, the adhesive Ad used here has a viscosity when applied in a range of 2300 to 6000 mPa·s.

FIGS. 11, 12, and 13 are diagrams schematically showing processes of bonding the LED 34 to the uneven pattern VP of the light guide LG.

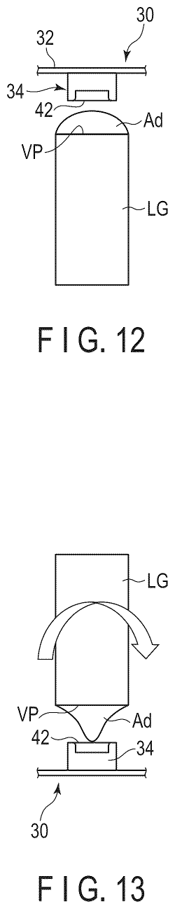

In bonding, as shown in FIG. 11, first, while the incident surface EF of the light guide LG and the uneven pattern VP are directed vertically upward, the adhesive Ad is applied to predetermined positions on the uneven pattern VP in the order using a dispenser 50. Next, as shown in FIG. 12, the light source device 30 is placed so that the light emitting surface 42 of the LED 34 opposes the adhesive Ad. At this time, the light source device 30 is disposed so as to create a slight gap between the light emitting surface 42 and the adhesive Ad.

In this state, as shown in FIG. 13, the light guide LG and the light source device 30 are inverted by substantially 180 degrees. Then, the adhesive Ad hangs down and is brought into contact with the light emitting surface 42 of the LED 34, and then wetting and spreading over substantially the entire surface of the light emitting surface 42. After that, the adhesive Ad cures, and the LED 34 is adhered onto the uneven pattern VP of the light guide LG.

Note that in the above-described adhesive application process and adhesion process, the adhesive Ad applied on the uneven pattern VP of the light guide LG almost flows out in the first direction Y and the second direction Z as shown in FIG. 10. However, the wall constituted by the convex portions CV in the first direction Y serves to prevent it from wetting and spreading widely in the first direction Y. At the same time, as to the second direction Z, the surface tension acts on the adhesive flowing out from between the portions of the uneven pattern VP, and thus the adhesive Ad is held on the uneven pattern VP without flowing out to the first main surface S1 and the second main surface S2. With this configuration, it is possible to sufficiently ensure the coating height of the adhesive Ad, thereby improving the adhesion of the LEDS. At the same time, the occurrence of contamination caused by spill out of adhesive can be prevented.

As shown in FIGS. 4 and 5, the light guide LG and the light source device 30 are disposed in the case 23 with four LEDs 34 adhered onto the uneven pattern VP of the incident surface EF of the light guide LG. The wiring substrate 32 of the light source device 30 opposes the short side plate 16D of the case 23 and is attached to the short side plate 16D by the double-sided tape TP2.

As shown in FIGS. 2 and 4, the backlight device 20 configured as described above is disposed to oppose the rear surface of the display panel 12 and is attached to the first substrate SUB1 of the display panel 12 by a framed double-sided tape TP1. At this time, the double-sided tape TP1 is attached to the peripheral portion of the first substrate SUB1, that is, the frame area ED, and its outer edge coincides with the outer edge of the first substrate SUB1. The light guide LG and the first and second optical sheets OS1 and OS2 are positioned parallel to the display panel 12 so as to oppose the entire surface of the display area DA. When a drive current is supplied to the LEDs 34 via the wiring substrate 32, the LEDs 34 are turned on to emit light from the light emitting surface 42. The light emitted from the LEDs 34 enters the light guide LG from the incident surface EF of the light guide LG via the adhesive Ad, propagates within the light guide LG, or is reflected by the reflective sheet RE, and then emitted from the first main surface (emission surface) S1 to the display panel 12 side.

According to the backlight device 20 and the liquid crystal display device 10 of this embodiment configured as described above, the uneven pattern VP is provided on the incident surface EF of the light guide LG, and the light emitting surface 42 of the LED 34 is fixed to the uneven pattern VP by the adhesive applied on the uneven pattern VP. That is, the gap between each LED 34 and the incident surface EF of the light guide LG is filled with the adhesive Ad to fill this gap. Therefore, the loss of light caused by the above-described gap can be significantly reduced. Further, with the uneven pattern VP thus provided, it is possible to prevent the adhesive Ad from wetting and spreading significantly to the surrounding area. Thus, the LEDs can be adhered while maintaining a sufficient coating height of the adhesive. In this manner, the adhesion of the LEDs can be improved and the occurrence of contamination due to spill out of adhesive can be prevented.

As described above, according to this embodiment, a light guide, an illumination device, and a display device can be obtained, which can reduce light loss without causing adhesion errors or the occurrence of contamination.

Note that in the first embodiment, the number of LEDs 34 installed is not limited to four, but can be increased or decreased as needed or according to the dimensions of the LEDs. Further, the adhesive Ad is not limited to the OCR described above, but other optical adhesives can be selected as appropriate.

Next, backlight devices and liquid crystal display devices according to modified examples and other embodiments will be described. In the modified examples and other embodiments, which will be provided below, parts identical to those of the first embodiment will be denoted by the same reference symbols, and their detailed descriptions will be omitted or simplified. The detailed descriptions thereof will mainly focus on parts that differ from those of the first embodiment.

In the embodiments mentioned above, the uneven pattern of the light guide is not limited to a saw blade shape, but can be changed in various ways.

### First Modified Example

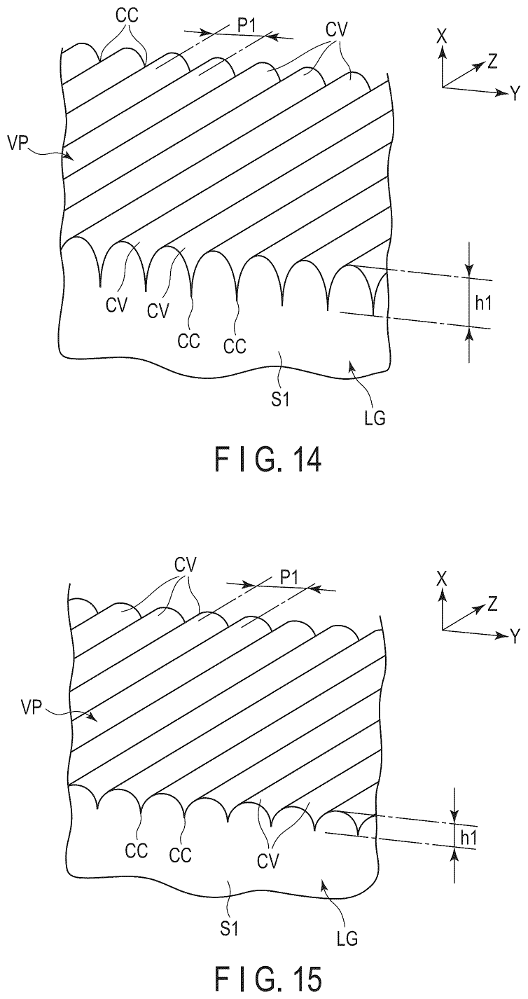

FIG. 14 is a perspective view showing an uneven pattern of a light guide according to the first modified example.

As shown in the figure, according to the first modified example, the uneven pattern VP of the light guide LG is constituted by a plurality of convex portions CV each having a semi-elliptical cross section and a plurality of concave portions CC each having approximately a triangular cross section, arranged alternately. The convex portions CV and concave portions CC are formed over the entire width of the light guide LG in the second direction Z.

Each of the convex portions CV is formed to have a protrusion height h1 in a range of 0.01 to 0.4 mm, for example. The pitch P1 between each adjacent pair of the convex sections CV in the longitudinal direction Y is set to, for example, 0.05 to 0.3 mm.

### Second Modified Example

FIG. 15 is a perspective view showing an uneven pattern of a light guide according to the second modified example.

As shown in the figure, according to the second modified example, the uneven pattern VP of the light guide LG is constituted by a plurality of convex portions CV each having a semi-circular cross section and a plurality of concave portions CC each having approximately a triangular cross section, arranged alternately. The convex portions CV and the concave portions CC are formed over the entire width of the light guide LG in the second direction Z.

Each of the convex portions CV is formed to have a protrusion height h1 in a range of 0.01 to 0.4 mm, for example. The pitch P1 between each adjacent pair of the convex sections CV in the longitudinal direction Y is set, for example, in a range of 0.05 to 0.3 mm.

### Third Modified Example

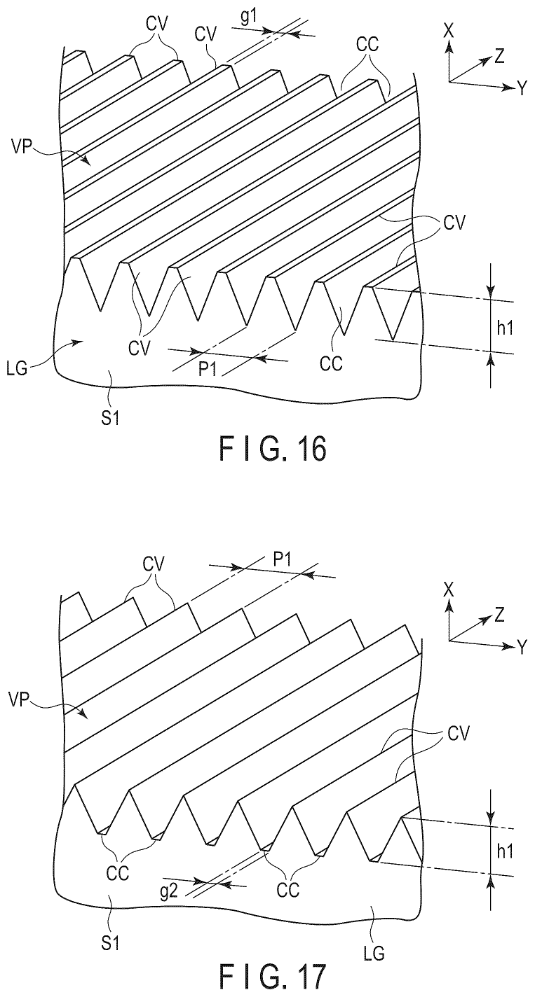

FIG. 16 is a perspective view showing an uneven pattern of a light guide according to the third modified example.

As shown in the figure, according to the third modified example, the uneven pattern VP of the light guide LG is constituted by a plurality of convex portions CV each having a trapezoidal cross section and a plurality of concave portions CC each having a triangular cross section, arranged alternately. The convex portions CV and the concave portions CC are formed over the entire width of the light guide LG in the second direction Z.

Each of the convex portions CV is formed to have a protrusion height h1 in a range of 0.01 to 0.4 mm, for example. The pitch P1 between each adjacent pair of the convex sections CV in the longitudinal direction Y is set, for example, in a range of 0.05 to 0.3 mm. The width g1 of an upper bottom of the convex portion CV in the longitudinal direction Y is set to ⅕ or less of the pitch P1.

### Fourth Modified Example

FIG. 17 is a perspective view showing an uneven pattern of a light guide according to the fourth modified example.

As shown in the figure, according to the fourth modified example, the uneven pattern VP of the light guide LG is constituted by a plurality of convex portions CV each having a triangular cross section and a plurality of concave portions CC each having a trapezoidal cross section, arranged alternately. The convex portions CV and the concave portions CC are formed over the entire width of the light guide LG in the second direction Z.

Each of the convex portions CV is formed to have a protrusion height h1 in a range of 0.01 to 0.4 mm, for example. The pitch P1 between each adjacent pair of the convex sections CV in the longitudinal direction Y is set, for example, in a range of 0.05 to 0.3 mm. The width g2 of an upper bottom of the convex portion CV in the longitudinal direction Y is set to ⅕ or less of the pitch P1 of the convex portions CV.

### Fifth Modified Example

In the examples discussed above, the direction of extension of the convex portions and concave portions of the uneven pattern VP is not limited to the thickness direction of the light guide LG (second direction Z), but can be set in any other direction.

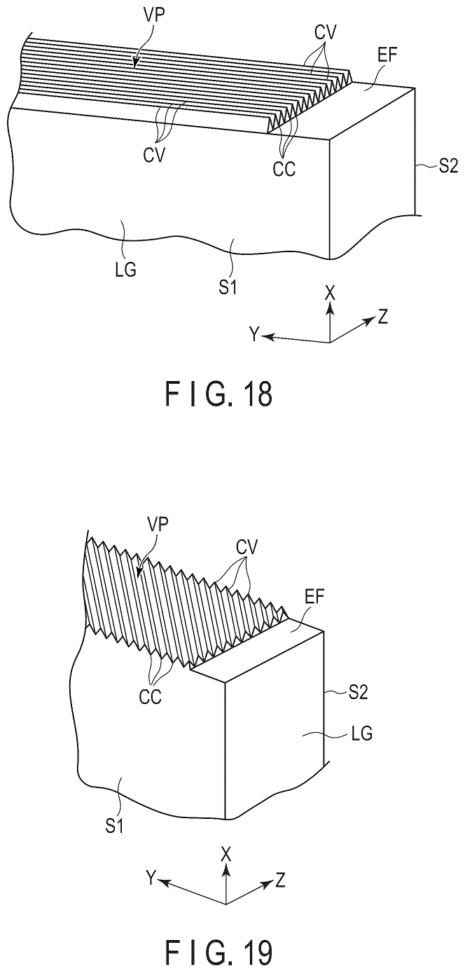

FIG. 18 is a perspective view showing an uneven pattern of a light guide according to the fifth modified example.

As shown in the figure, according to the fifth modified example, the uneven pattern VP provided on the incident surface EF of the light guide LG is formed, for example, into a saw blade pattern. That is, the uneven pattern VP includes a plurality of convex portions CV each having a triangular cross-section and a plurality of concave portions CC each having a triangular cross section, arranged alternately. The convex portions CV and the concave portions CC are formed over substantially the entire length of the incident surface EF of the light guide LG in the longitudinal direction (first direction) Y. Further, the convex portions CV and concave portions CC are provided alternately in the width direction Z of the light guide LG and formed over substantially the entire length of the width direction. The pitch P1 of the convex portions CV in the width direction Z and the protrusion height h1 of the convex portions CV are set similarly to the pitch P1 and height h1 in the first embodiment described above.

### Sixth Modified Example

FIG. 19 is a perspective view showing an uneven pattern of a light guide according to the sixth modified example.

As shown in the figure, according to the sixth modified example, the plurality of convex portions CV and the plurality of concave portions CC of the uneven pattern VP provided on the incident surface EF of the light guide LG each extend in a direction inclined by an angle smaller than 90 degrees, for example 45 degrees, with respect to the longitudinal direction Y. The plurality of convex portions CV and the plurality of concave portions CC are provided over substantially the entire length of the incident surface EF in the longitudinal direction Y as well as over substantially the entire length in the width direction Z. The pitch P1 of the convex portions CV and the protrusion height h1 of the convex portions CV are set similarly to the pitch P1 and height h1 in the first embodiment described above.

### Second Embodiment

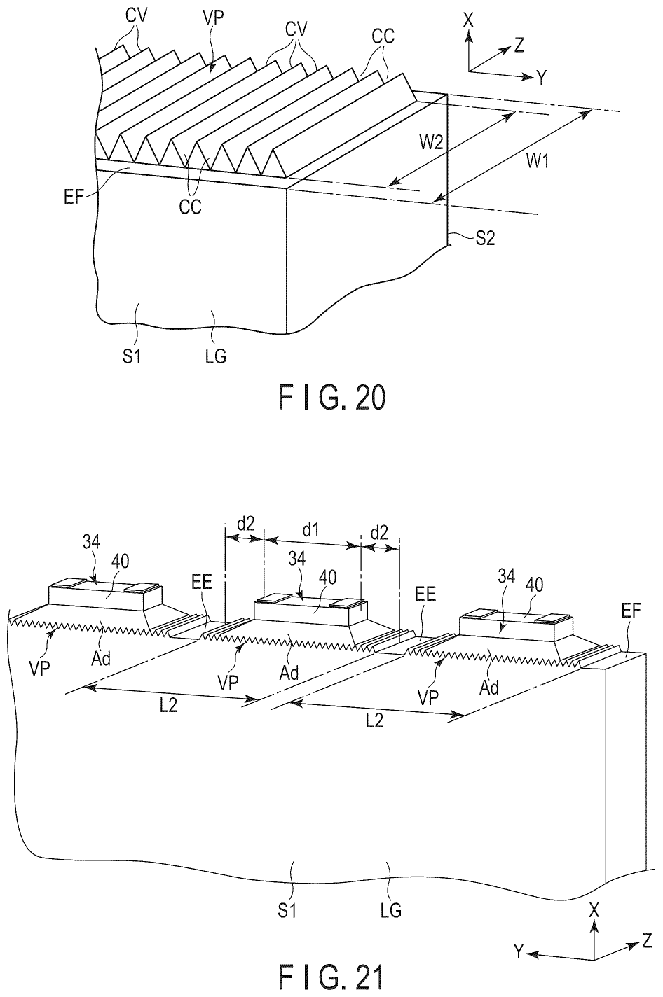

FIG. 20 is a perspective view showing a light guide of a liquid crystal display device according to the second embodiment.

According to the second embodiment, with regard to the uneven pattern VP of the light guide LG, the length W2 of the convex portions CV and the concave portions CC in the second direction Z is set shorter than the width (thickness) W1 of the light guide LG. For example, the length W2 is set to be ⅘ or greater and less than 5/5 of the width W1 and further greater than or equal to the width of the light emitting surfaces of the LEDs 34.

With use of the light guide LG of the second embodiment, advantageous effects similar to those of the first embodiment described above can be obtained.

### Third Embodiment

FIG. 21 is a perspective view of showing a light guide and LEDs of a liquid crystal display device according to the third embodiment. As shown in the figure, according to the third embodiment, the uneven pattern VP of the light guide LG is provided not over the entire incident surface EF of the light guide LG, but only in a plurality of regions where the LEDs 34 are attached. In other words, the uneven pattern VP of the light guide LG is provided to be divided into multiple, in this case, four pattern forming regions, in the longitudinal direction Y, and between each adjacent pair of the pattern forming regions, a flat region EE without a pattern is provided.

The length L2 of each pattern forming region where the uneven pattern VP is provided is set greater than the length d1 of the LED 34 in the first direction Y. Further, each pattern forming region is formed so that, for example, the distance d2 between the end portion of the respective LED 34 in the longitudinal direction and the flat portion EE is 0.1 to 1.2 mm.

For the uneven pattern VP provided in each pattern forming region, the uneven pattern according to any one of those of the first embodiment and the uneven patterns of the modified examples 1 to 4 may be applied. Further, the LEDs 34 are attached to the respective uneven pattern VP by the adhesive Ad.

With use of the light guide LG of the third embodiment, advantageous effects similar to those of the first embodiment described above can be obtained.

### Fourth Embodiment

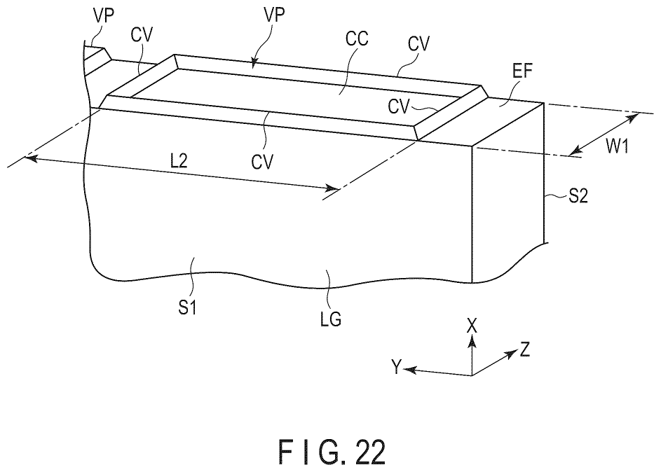

FIG. 22 is a perspective view showing a light guide of a liquid crystal display device according to the fourth embodiment. As shown in the figure, according to the fourth embodiment, the uneven pattern VP provided on the incident surface EF of the light guide LG includes a rectangular frame-shaped convex portion CV and a rectangular concave portion CC. The convex portion CV has, for example, a triangular cross section, and its protrusion height is set similarly to the protrusion height h1 of the convex portion in the first embodiment described above. The convex portion CV includes a pair of long side portions extending in the longitudinal direction Y of the incident surface EF and a pair of short side portions extending in the width direction Z. Each of the short side portions extends over the entire length of the width direction Z, and the pair of long side portions extend along respective side edges of the incident surface EF. The length L2 of each of the long side portions in the longitudinal direction Y is greater than the length d1 of the respective LED 34 to be adhered (see FIG. 21). The concave portion CC is defined on an inner side of the frame-shaped convex portion CV and includes a bottom surface that is flush with the incident surface EF.

In order to adhere the LED 34, the adhesive Ad is filled into the concave portion CC. Thus, the LED 34 is adhered onto the uneven pattern VP and the incident surface EF of the light guide LG by the adhesive Ad.

With use of the light guide LG according to the fourth embodiment, advantageous effects similar to those of the first embodiment described above can be obtained.

Note that in the second to fourth embodiments described above, other configurations of the liquid crystal display device and the backlight device 20 are identical to those of the liquid crystal display device and the backlight device described in the first embodiment

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Based on each of the above-described configurations as embodiments of the present invention, all configurations that can be designed and changed as appropriate by those skilled in the art and implemented are also within the scope of the invention, as long as they encompass the gist of the invention. For example, the shapes of the liquid crystal panel, the components of the backlight device, and the case are not limited to rectangular shapes, but may be other shapes such as a polygonal shape, a circular shape, an oval shape, and a shape combining these shapes in plan view. Further, the liquid crystal display and backlight device are not limited to of a flat shape, but may be partially or fully curved or inclined. The materials of the components are not limited to those of the examples described above, but can be selected in various ways.

Other effects brought about by the above-described embodiments that are obvious from the description herein or that may be conceived by those skilled in the art are naturally considered to be brought about by the present invention.

What is claimed is:

1. An illumination device comprising:
a light guide including an emission surface and an incident surface, the incident surface including an uneven pattern with a convex portion having a height of 0.01 to 0.4 mm; and
a light emitting element provided to oppose the incident surface and adhered to the uneven pattern by an adhesive.

2. The illumination device of claim 1, wherein
the uneven pattern includes a plurality of convex portions and a plurality of concave portions each extending in a first direction, and the plurality of convex portions and plurality of concave portions are alternately aligned in a second direction intersecting the first direction.

3. The illumination device of claim 2, wherein
an alignment pitch of the plurality of convex portions in the second direction is set to 0.05 to 0.3 mm.

4. The illumination device of claim 1, wherein
each of the convex portions has a triangular, semi-elliptical, semi-circular, or trapezoidal cross-sectional shape.

5. The illumination device of claim 1, wherein
the light emitting element includes a light emitting surface opposing the uneven pattern, and the light emitting surface is adhered to the uneven pattern by the adhesive.

6. The illumination device of claim 5, wherein
the adhesive is a transparent resin adhesive having a refractive index lower than or equal to a refractive index of the light guide and further 1.4 or higher and having a haze of 5% or less.

7. The illumination device of claim 2, wherein
the incident surface is formed into a rectangular shape with a pair of long sides and a pair of short sides, and
the first direction is a direction parallel to the short sides and the second direction is a direction parallel to the long sides.

8. The illumination device of claim 2, wherein
the incident surface is formed into a rectangular shape with a pair of long sides and a pair of short sides, and
the first direction is a direction parallel to the long sides and the second direction is a direction parallel to the short sides.

9. The illumination device of claim 2, wherein
the incident surface is formed into a rectangular shape with a pair of long sides and a pair of short sides, and
the first direction is a direction inclined by an angle less than 90 degrees with respect to a direction parallel to the long sides, and the second direction is a direction orthogonal to the first direction.

10. The illumination device of claim 2, wherein
the incident surface is formed into a rectangular shape with a pair of long sides and a pair of short sides, and
the uneven pattern is provided over a region of substantially an entire length of the incident surface in a direction parallel to the long sides.

11. The illumination device of claim 2, wherein
the incident surface is formed into a rectangular shape with a pair of long sides and a pair of short sides, and
the uneven pattern is provided dividedly at a plurality of locations on the incident surface at intervals in a direction parallel to the long sides.

12. The illumination device of claim 10, wherein
the uneven pattern is provided in a region of ⅘ or greater of a length of the short sides in a direction parallel to the short sides.

13. The illumination device of claim 11, wherein
the unevenness pattern is provided in a region of ⅘ or greater of a length of the short sides in a direction parallel to the short sides.

14. A display device comprising:
a display panel; and
an illumination device provided to oppose the display panel, and
the illumination device comprising a light guide including an emission surface opposing the display panel and an incident surface, the incident surface including an uneven pattern with a convex portion having a height of 0.01 to 0.4 mm, and a light emitting element provided to oppose the incident surface and adhered to the uneven pattern by an adhesive.

15. A light guide of an illumination device, comprising:
an emission surface and an incident surface; and
an uneven pattern provided on the incident surface, including a convex portion having height of 0.01 to 0.4 mm.
